(19) United States
(12) Patent Application Publication
(10) Pub. No.: US 2023/0071964 A1
(43) Pub. Date: Mar. 9, 2023

(54) CHEMICALLY STRENGTHENED GLASS SHEET AND METHOD FOR ITS PRODUCTION

(71) Applicant: SCHOTT AG, Mainz (DE)

(72) Inventors: Yigang Li, Shanghai (CN); Thomas Seuthe, Jena (DE); Bin Chen, Shanghai (CN); Sandra von Fintel, Jena (DE)

(73) Assignee: SCHOTT AG, Mainz (DE)

(21) Appl. No.: 17/931,066

(22) Filed: Sep. 9, 2022

(30) Foreign Application Priority Data
Sep. 9, 2021 (EP) 21 195 679.2
Mar. 23, 2022 (DE) 10 2022 106 793.9

(51) Int. Cl. C03C 21/00; C03C 3/091

(52) U.S. Cl. CPC C03C 21/002; C03C 3/091

(57) ABSTRACT

A chemically strengthened glass sheet is provided that has a thickness of at least 3.3 mm and at most 6.0 mm and a composition, in mol% on an oxide basis, comprising the following components:
SiO₂ 65 to 85
B₂O₃ 3 to 13
∑ (R₂O + RO) 3 to 19,
wherein R₂O represents any of Li₂O, Na₂O, and K₂O, and any combination thereof, and
wherein RO represents any of MgO, CaO, SrO and BaO, and any combination thereof.

### CROSS REFERENCE TO RELATED APPLICATIONS

This application claims benefit under 35 USC §119 of Eurpoean application EP 21 195 679.2 filed Sep. 9, 2021 and German application DE 10 2022 106 793.9 filed Mar. 23, 2022, the entire contents of both of which are incorporated herein by reference.

### BACKGROUND

### 1. Field of Invention

The invention generally relates to glass sheets, in particular to chemically strengthened glass sheets, as well as to a method of production for these glass sheets. More particularly, the invention relates to glass sheets comprising a borosilicate glass.

### 2. Description of Related Art

Glass sheets are widely used as viewing panels or protective sheets. For example, it is known to use glass sheets as windshields in automotive applications, or as covers in smartphones.

When using glass sheets as protective covers for sensor applications, the glass sheets need to meet several specifications. In particular, in case of optical sensors, the glass sheets used for protective housings and/or covers should show a high resistance against mechanical failure such as breakage, especially when the glass surface has been scratched or abraded. Therefore, the glass sheet surfaces should have a high resistance against scratch formation and/or abrasion, Further, a high weathering or corrosion resistance is required.

Glass sheets comprising or consisting of soda lime glass show neither satisfactory performance in corrosion resistance nor in mechanical strength.

While it is known to use borosilicate glasses instead of soda lime glasses, as borosilicate glasses has superior weathering and/or corrosion resistance as well as a superior resistance to surface defects such as scratches compared to soda lime glasses, their mechanical strength with regard to breakage is still not sufficient.

In order to provide high mechanical strength glass articles, such as glass sheets, may be strengthened, for example by tempering or by ion exchange (so-called chemical toughening or chemical strengthening). For example, it is known to chemically strengthen alumosilicate glasses (AS glasses) or lithium containing alumosilicate glasses (so-called LAS glasses). In particular chemically strengthened LAS glasses are known for their high mechanical strength that leads to a high resistance against breakage. However, because of the composition and the resulting glass structure, chemically strengthened LAS glass articles are rather susceptible to scratching and/or abrasion, especially compared to glass articles made of glasses comprising boron oxide.

For example, international patent application WO 2019/130285 A1 relates to a laminate, for example for use as a windshield, comprising an outer borosilicate glass layer that may be strengthened. However, WO 2019/130285 A1 does neither disclose any compositional details of the borosilicate glass nor relate to specifics of the strengthening process.

International patent application WO 2019/161261 A1 relates to LiDAR-covers with laminate glasses. The laminated glass articles comprise a core layer and two clad layers, wherein the clad layers have a lower CTE than the core layer. The glasses may comprise a borosilicate glass. The laminated glass article according to WO 2019/161261 A1 further is configures to absorb visible light.

US 10252935 B2 discloses a chemically tempered glass plate. The glass plate may be strengthened so that a high compressive stress of more than 200 MPa and, hence, a high breaking strength, may be achieved.

US 2020/0132521 A1 relates to a sensor module and a protective glass therefore. The protective glass may be chemically strengthened, and very high compressive stresses of about 400 MPa or more may be achieved. Further, the content of B₂O₃ should be minimized in order to avoid damage to production facilities and/or the formation of striae.

International patent application WO 2020/247245 A1 relates to hardened optical windows for LiDAR applications. Compressive stresses of glass windows may be very high. For example, maximum compressive stress values of up to about 1000 MPa may be achieved.

However, none of the glass articles of the state of the art combines high mechanical strength against breakage and high surface resistance against abrasion and/or scratching.

Therefore, there is a need for glass articles combining a sufficient mechanical strength for cover applications while providing, at the same time, a good abrasion and/or scratch resistant surface. Further, there is a need for a manufacturing process of such articles.

### SUMMARY

The object of the present invention is to provide glass articles, in particular glass sheets, that overcome the drawbacks of the glass articles of the state of the art at least partially. A further object is to provide a manufacturing process for such glass articles, in particular glass sheets.

The problem of the invention is solved by the subject-matter of the description and the figures of the present application.

The invention therefore relates to a glass sheet, in particular a chemically strengthened glass sheet, that has a thickness of at least 3.3 mm, preferably at least 3.5 mm, more preferably at least 3.8 mm, and at most 6 mm, preferably at most 5 mm, more preferably at most 4.5 mm and that comprises, in mole-% on an oxide basis, the following components:
SiO₂ 65 to 85
B₂O₃ 3 to 13
∑ (R₂O + RO) 3 to 19

wherein R₂O represents any of Li₂O, Na₂O, and K₂O, and any combination thereof, and wherein RO represents any of MgO, CaO, SrO and BaO, and any combination thereof.

Preferably, the glass sheet shows no breakage in two cycles of gravel test according to VW80000 M-02 (ISO 20567-1), preferably for a glass sheet size of 136 by 63 mm².

Additionally or alternatively, the glass sheet, for a glass sheet size of 136 by 63 mm², preferably passes a ball drop test according to PV 3905 with a drop height of at least 30 cm using a 500 g steel ball with a diameter of 50 mm. “Passing a ball drop test”, in the sense of the present disclosure means, that no breakage occurs for drop heights of less than 30 cm. Preferably, even higher drop heights than 30 cm do not result in breakage of the glass sheet. Therefore, according to an embodiment, the glass sheet of the disclosure passes a ball drop test according to PV 3905 with a drop height of at least 35 cm, preferably at least 40 cm and more preferably at least 45 cm.

Drop height is preferably determined as average drop height for a minimum of at least 4 samples and up to 10 samples. However, if only few samples are available, drop height may also be determined using a single test sample.

Such as glass sheet offers several advantages.

The glass sheet according to the disclosure comprises network-forming oxide SiO₂ in an amount between 65 to 85 percent by mole, as well as B₂O₃, an oxide that may both be regarded as network former or as an intermediate oxide in an amount of at least 3 percent by mole and up to 13 percent by mole. The high content of SiO₂ and B₂O₃ in the glass sheets according to the disclosure of at least 68 percent by mole, in particular the high content of SiO₂ of up to 85 percent by mole, leads to a rather rigid glass network that is able to take up and retain mechanical stresses induced, for example, by ion exchange. However, at the same time, the content of B₂O₃ ensures that even for high amounts of SiO₂, the glass may still be obtained in a conventional glass melting process, as B₂O₃ is a component lowering the melting temperature of glass melts. Therefore, the content of B₂O₃ is at least 3 percent by mole. Further, B₂O₃ improves the scratch and/or abrasion resistance of the glass sheet surface. However, in order to avoid damages to glass productions facilities, such as a glass tank, the B₂O₃ content in the glasses according to the disclosure is limited and the glass sheet comprises at most 13 percent by mole of B₂O₃. A further advantage of B₂O₃ is that boron-containing glasses and glass articles, such as glass sheets, comprising or consisting of such boron containing glasses show a higher chemical resistance and, thus, corrosion resistance.

The glass sheet according to the disclosure further comprises further oxides R₂O and/or RO, wherein a sum of these oxides R₂O and RO is between at least 3% by mole and at most 19 % by mole.

Here, R₂O represents any of Li₂O, Na₂O, and K₂O, and any combination thereof, and RO represents any of MgO, CaO, SrO, and BaO, and any combination thereof.

Oxides R₂O and RO, that is, alkali oxides and earth alkali oxides, may also be regarded, from a functional point of view, as so-called network modifier oxides, in contrast to network forming oxides such as SiO₂.

Network modifier oxides are important components in glass production, as these components lower glass melting temperature and/or melt viscosity, thereby enabling cost-efficient production. Further, in case the glass article in question is to be chemically toughened, an alkali oxide such as Li₂O and/or Na₂O is a necessary component of the glass in order to enable ion exchange, that is, exchange of a smaller alkali ion for a larger alkali ion to be incorporated in the glass network in a surface layer of the glass sheet or glass article, thereby inducing stress - that is, compressive stress - in the glass network. That is, by inducing a compressive stress in a surface layer of the glass sheet, the article as a whole is strengthened. It is noted here that during ion exchange, usually both sides or principle surfaces of a glass sheet are compressively stressed, as both sides or principle surfaces of the glass sheet are immersed in an ion exchange bath. In order to provide for a glass article that may be chemically toughened or strengthened by ion exchange, the glass article, in particular, the glass sheet according to the disclosure comprises at least 3% by mole of RO and R₂O, as specified further above, and may preferably be higher, in order to enable particularly efficient chemical toughening.

However, as alkali and earth alkali oxides modify and weaken the glass network, the content of RO and R₂O components should not be too high. A too high amount of these oxides may lead to decreased resistance to chemical attack and, while such glasses and glass articles comprising or consisting of such glasses may be easily chemically toughened, even so that very high compressive stresses may be achieved, such glass and glass articles may also have a rather low resistance against surface deterioration, for example caused by scratching and/or abrasion. Therefore, the overall amount of oxides RO and R₂O should not be higher than 19 percent by mole.

Surprisingly, inventors found out that by providing a glass sheet with a composition in the above specified ranges, it is possible not only to obtain, during ion exchange, a chemically toughened or strengthened glass sheet having a sufficiently high mechanical resistance against breakage, but also to provide a glass sheet with superior scratch resistant performance.

A suitable wear test in order to illustrate the superior performance of the glass sheet according to the disclosure is a gravel test according to VW80000 M-02 (ISO 20567-1). The test procedure according to VW80000 M-02 (ISO 20567-1) is an established test procedure in order to determine stone-chip resistance of surfaces, such as paint or coating surfaces, for example, and may also be used for determining the surface quality of uncoated surfaces such as glass sheet surfaces. After performing the test according to VW80000 M-02 (ISO 20567-1), the glass sheet shows no break after two cycles.

Additionally or alternatively, the chemically tempered glass sheet, for a glass sheet size of 136 by 63 mm², preferably passes a ball drop test according to PV 3905 with a drop height of at least 30 cm or even more, for example a drop height of at least 35 or at least 45 mm, using a 500 g steel ball with a diameter of 50 mm. That is, according to an embodiment, the chemically strengthened glass sheet of the disclosure has a high resistance to breakage. Preferably, the chemically strengthened glass sheet of the disclosure at the same time exhibits superior surface resistance, that is, a high resistance of the glass sheet surface against mechanical wear such as scratching and/or abrasion.

According to an embodiment, a sum of components SiO₂, B₂O₃ and Al₂O₃ in the glass sheet, given in mol% on an oxide basis, is at least 80, preferably at least 84, more preferably at least 90, and particularly preferably at most 98, more particularly preferably at most 94 and most particularly preferably at most 91. Further, the glass sheet has a network modifier oxide content, given in mol% on an oxide basis, of at least 3 and preferably at most 19, more preferably at most 15, most preferably at most 11.

Here, Li₂O, Na₂O, K₂O, MgO, CaO, SrO, BaO or any combination thereof are considered network modifier oxides.

According to this embodiment of the glass sheet, Al₂O₃ is a further component of the glass sheet. Al₂O₃, as glass component, may either be regarded as a network former or an intermediate oxide, that is, an oxide that may promote network forming as well as induce changes or modifications to a glass network, depending on the exact nature of a specific glass material or glass composition and the introduced amount of Al₂O₃.

Al₂O₃ is a glass component that may promote a high surface hardness, that is, resistance against surface wear. However, at the same time, a high Al₂O₃ content in the glass material and, hence, the glass sheet may give rise to high melting temperatures.

Further, it is known that the number of non-bridging oxygen atoms is reduced by the addition of Al₂O₃ to an alkali silicate glass. In fact, this addition can be advantageous for the build-up of a rigid network, but as pointed out above is to be seen as critical with respect to the meltability of the resulting glass and/or glass article, such as a glass sheet. Furthermore, the chemical stability of the glass or the resulting glass article, such as a glass sheet, may be decreased for a too high Al₂O₃ content of the glass and/or the glass sheet. Therefore, according to embodiment, of the glass or of the glass article, the percentage of Al₂O₃ in the glass or glass article is limited.

However, inventors found that the Al₂O₃ content may, in the glass sheets according to the disclosure, vary in a rather large range. Quite surprisingly, inventors found that is it not the Al₂O₃ content taken alone, but rather the overall content of oxides Al₂O₃, B₂O₃ and SiO₂ that may, according to an embodiment, promote the advantageous properties of the chemically strengthened glass sheets of the disclosure. That is, a rather low SiO₂ content of only 65 to 75 % by mole, for example, may be compensated for by a rather high Al₂O₃ content, whereas a low content of Al₂O₃ is possible for high SiO₂ contents such as, for example, 78 % by mole or even more, and/or by adjusting the B₂O₃ content in the further above specified ranges, as long as the specifications for the overall content of all three components remain in the specified range of at least 80 %, preferably at least 84 %, more preferably at least 88 %, and particularly preferably at most 98 %, more particularly preferably at most 94 % and most particularly preferably at most 91 %, wherein all percentages are given in mol% on an oxide basis.

Further surprisingly, inventors found that it is not only the overall network former and intermediate oxide content, represented by the above indicated overall content of components SiO₂, B₂O₃ and Al₂O₃ that may be varied in a rather large amount as discussed above, but also that the network modifier amount may be varied in a large range, as long as the overall network modifier content of the glass material and, hence, the glass sheet, is kept within the above indicated ranges. Here, as already specified above, Li₂O, Na₂O, K₂O, MgO, CaO, SrO, BaO or any combination thereof are considered network modifiers (or network modifier oxides).

Inventors further found that a special regard should be kept upon the content of critical components SiO₂ and B₂O₃ in the glass sheet. Very advantageous chemically toughened or strengthened glass sheets may be obtained for a sum of the components SiO₂ and B₂O₃ in the glass sheet, given in mol% on an oxide basis, between at least 72, preferably at least 75.5, particularly preferably at least 88, more particularly preferably at least 90, and preferably at most 95. These glass sheets show a very high wear resistant glass sheet surface, especially with regard to scratches and/or abrasion, combined with a high resistance against chemical attack.

In general, without being restricted to any of the embodiments of the disclosure, the indicated components of the chemically strengthened glass sheet further comply with a constraint relating to the content of tetrahedrally and trigonally coordinated boron.

Boron as well as aluminum atoms tend to be tetrahedrally coordinated in a glassy network, especially in the presence of alkaline and alkaline earth oxides. These tetrahedrons fit quite well into glassy networks formed mostly of silicon tetrahedrons.

Further, as shown by Sebastian Bruns, Tobias Uesbeck, Dominik Weil, Doris Möncke, Leo van Wüllen, Karsten Durst und Dominique de Ligny, Influence of Al₂O₃ Addition on Structure and Mechanical Properties of Borosilicate Glasses, Front. Mater., 28 Jul. 2020, aluminum ions tend to be tetrahedrally coordinated so that in case of an oxygen deficiency due to a deficiency in alkaline and/or alkaline earth elements providing oxygen atoms, boron ions will be trigonally coordinated.

The amount of trigonally coordinated boron ions, c_{B2O3,}_{trigonal}, is given as follows:

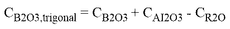

wherein c, in each case, refers to the content of the respective component, given in mol%, and wherein
c_{B2O3} refers to the total content of B₂O₃ in the respective glass composition,
c_{B2O3},_{trigonal} refers to the content of trigonally coordinated B₂O₃,
c_{A12O3} refers to the total content of Al₂O₃, and
c_{R2O} is the sum of components Li₂O, Na₂O, and K₂O.

According to an embodiment, c_{B2O3,}_{trigonal} > 0.

This is advantageous, as in this case, the glass of the glass sheet comprises so called boroxol rings, that is, a planar structure (see Christian Hermansen, Quantitative Evaluation of Densification and Crack Resistance in Silicate Glasses, Master Thesis, Aalborg University, Denmark, July 5th 2011). These boroxol rings tend to aggregate, wherein adjacent boroxol rings may glide one upon the other. That is, these boroxol rings may form, within the glass network, domains with a stacked structure. In parallel to these stacks, the glass network may absorb forces acting upon the glass without any breaking of chemical bonds. In consequence, the strength of the glass network, and, thus of any glass article such as a glass sheet, is improved. For example, a glass sheet comprising such a glass material may show an improved resistance with respect to gravel testing.

The presence of any trigonally coordinated boron may be determined via 11BMAS-NMR analysis.

Boroxol rings within a glass network therefore may also be regarded as a kind of intrinsic lubricant which counteracts brittleness and, at the same time, enhances resistance against surface damages and defects.

However, at the same time, a too high amount of trigonally coordinated boron and, therefore, boroxol rings may negatively affect the chemical resistance, especially the resistance against alkali attack, as alkaline ions may propagate quite quickly in parallel to the aforementioned stacks of boroxol rings.

Therefore, according to a further embodiment, c_{B2O3,}_{trigonal} may preferably be at least 3 mol%, more preferably at least 5 mol%, and further preferably at most 10 mol%, preferably at most 9 mol%, and most particularly preferably at most 8 mol%.

According to a further embodiment, the amount of trigonally coordinated boron ions, c_{B2O3,}_{trigonal}, may also be given as follows: C_{B2O3,}_{trigonal} = c_{B2O3} + c_{A12O3} - c_{Na2O} - c_{K2O} - c_{CaO}.

According to a further embodiment, therefore, C_{B2O3,}_{trigonal} is at least 2 mol%, preferably at least 3 mol%, but at most 10 mol%, preferably at most 9 mol%.

The following definitions apply in the scope of the present disclosure:

An exchange bath is understood to be a salt melt, wherein this salt melt is used in an ion exchange method for a glass or a glass article. In the scope of the present disclosure, the terms: exchange bath and ion exchange bath are used synonymously.

Usually, salts are used in technical-grade purity for exchange baths. This means that despite the use of only sodium nitrate, for example, as the initial substance for an exchange bath, certain impurities are also comprised in the exchange bath. In this case, the exchange bath is a melt of a salt, for example, of sodium nitrate, or of a mixture of salts, for example, a mixture of a sodium salt and a potassium salt. In this case, the composition of the exchange bath is indicated in such a way that it refers to the nominal composition of the exchange bath without consideration of possibly present impurities. Therefore, insofar as a 100% sodium nitrate melt is stated in the scope of the present disclosure, this means that only sodium nitrate was used as the raw material. The actual content of the exchange bath of sodium nitrate may, however, deviate therefrom and this is also usual, since technical-grade raw materials in particular have a certain percentage of impurities. These are, however, usually less than 5 wt.%, referred to the total weight of the exchange bath, in particular less than 1 wt.%.

In a corresponding manner, for exchange baths that have a mixture of different salts, the nominal contents of these salts are indicated without consideration of impurities of the initial substances due to the technical grade. An exchange bath with 90 wt.% KNO₃ and 10 wt.% NaNO₃ thus may also have some small impurities that are caused, however, by the raw materials, and usually should be less than 5%, referred to the total weight of the exchange bath, in particular, less than 1 wt.%.

In addition, the composition of the exchange bath also changes in the course of the ion exchange, in particular, since ions, such as lithium and/or sodium ions, migrate from the glass or the glass article into the exchange bath due to the continued ion exchange. Such a change in the composition of the exchange bath due to aging is also present, of course, but is not considered as long as it is not otherwise explicitly stated. Rather, in the scope of the present disclosure, for indicating the composition of an exchange bath, the nominal original composition is put down.

In the scope of the present disclosure, a stress profile is understood as the application of mechanical stress in a glass article, such as a glass plate, for example, versus the thickness of the glass article considered, given in a diagram. In the scope of the present disclosure, insofar as a compressive stress profile is indicated, this is understood here as that portion of a stress profile, in which the stress assumes positive values, i.e., is greater than zero. Tensile stress, in contrast, has a negative sign.

In the scope of the present disclosure, a glass sheet is a plate-shaped or disc-shaped glass article and such a glass article is understood to be a glass article in which the lateral dimension is smaller in one spatial dimension, at least an order of magnitude smaller, than in the other two spatial directions, whereby these spatial directions are specified relative to a Cartesian coordinate system, in which these spatial directions each time run perpendicular to one another, and in this case, the thickness in the normal direction to the largest or main surface is measured from one main surface to the other main surface.

Since the thickness is at least one order of magnitude smaller than the width and length of the glass article, the width and length in this case can lie on the same order of magnitude. It is, however, also possible that the length is still clearly greater than the width of the glass article. Plate-shaped glass articles or glass sheets in the sense of the present disclosure can therefore also comprise a glass ribbon or strip.

In the sense of the present disclosure, a glass is understood to be a material and a glass article, such as a glass sheet is understood to be a product produced from the glass material and/or comprising the glass material, for example by shaping during hot forming. In particular, a glass article, such as a glass sheet, can be composed of glass or predominantly composed of glass; thus the glass material can contain up to at least 90 wt.% glass.

In the scope of the present disclosure, a chemical prestressing is understood as a process in which a glass article is immersed in a so-called exchange bath. Further, in the scope of the present disclosure, the expressions chemical prestressing, chemical toughening, chemical hardening and chemical strengthening are used synonymously, referring to glass articles such as glass sheets prestressed or toughenend or hardened or strengthened by an ion exchange process. During immersion in a so-called exchange bath, there occurs the exchange of ions. In the sense of the present disclosure, potassium exchange is understood in that potassium ions migrate from the exchange bath into the glass article or glass sheet, in particular into the surface of the glass article or glass sheet, thus, for example, are incorporated therein, whereby simultaneously small alkali ions, such as sodium, for example, migrate from the glass article or glass sheet into the exchange bath. Sodium exchange is understood in a corresponding way, in that sodium ions migrate from the exchange bath into the surface of the glass article or glass sheet, while in contrast, small ions, for example lithium ions migrate from the glass article or glass sheet, in particular from the surface of the glass article, into the exchange bath. As already described above, due to this ion exchange, a compressive stress zone is built up in the surface region of the glass article, for example, the glass sheet.

In the scope of the present document, maximum tensile stress is the value of the tensile stress in the center of the glass article, thus at a depth of half the thickness of the glass article.

The tensile stress is usually provided with a negative sign; in contrast, compressive stresses are given a positive sign, since compression and tension have correspondingly opposite directions. In the scope of the present disclosure, insofar as the value of a tensile stress is indicated without a sign being named, it is understood that this case involves the magnitude of the stress. The definition involves here the sign of the stress, as it is usually used by the person skilled in the art, the developer of prestressed protective glasses with respect to the sign of the stress. This directly deviates from the usual designation of compressive stress as negative and tensile stress as positive, as it is usually used in physics, for example. In the scope of the present disclosure, here, of course, as explained, the definition of stresses reverts back to how they are usually used in the glass industry.

The compressive stress depth for potassium exchange, that is, the exchange of sodium in the glass by potassium ions, if it is specified relative to the respective exchanged components or ions, is also referred to as the so-called “exchange depth”. In the scope of the present disclosure, the terms: exchange depth, compressive stress depth and the DoL are used as synonyms at least with respect to potassium-sodium ion exchange. For the sodium-lithium exchange, there is a difference between the DoL and the exchange depth. Further, for characterization of sodium exchange, often the compressive stress value at a depth of 30 µm is indicated (also referred to as CS(30)), as well as the depth of the compressive stress layer (DoCL).

In the scope of the present disclosure, the term: field strength of an ion is used according to Dietzel. In particular, this term is used referred to an oxidic glass matrix, wherein it is understood that this value may change, each time depending on the coordination number of the ion in question.

With respect to the terms: network modifier and network former, these are understood to be according to Zachariasen.

It has been shown, as pointed out above, that with respect to the build-up of a glass network that is as optimally prestressable as possible in an alkali silicate glass, the components B₂O₃, Al₂O₃ and SiO₂ are interrelated. Therefore, in principle, if the glass is accessible to an ion exchange, it must comprise alkali ions. Due to the content of alkali ions, the glass network is weakened, of course, since non-bridging oxygens arise. These can be reduced by adding Al₂O₃ and/or B₂O₃ as components to the glass. Varying these components in the above indicated ranges for each component, while ensuring that the sum of these components in the glass and/or the resulting glass article, such as a glass sheet, is kept within a certain range that has also been indicated above, is advantageous, since in this way, a stable, rigid network is obtained, which provides an at least sufficient chemical stability. The content of the above three components in the glass and/or in the glass article or glass sheet should not be too high, however, since if this were the case, the glass is no longer meltable, or no longer economically meltable.

For example, according to an embodiment, a very advantageous compositional range for a glass sheet is obtained for a chemically strengthened glass sheet comprising, in mol% on an oxide basis, the following components:
SiO₂ 79 to 85, preferably 80 to 85
Al₂O₃0.5 to 4
B₂O₃ 8 to 12
Na₂O2.5 to 5.2
K₂O0.3 to 1.8
MgO 0 to 3
CaO1.3 to 2.9.

Here, a high amount of SiO₂ ranging from 79 to 85 mol%, preferably 80 to 85 mol%, is combined with a rather low content in Al₂O₃ from only 0.5 to 4 mol%, whereas the content in B₂O₃ ranges from 8 to 12 mol%.

The glass sheet further comprises network modifiers such as Na₂O, CaO and K₂O. MgO, which is also a network modifier, is an optional component of a glass sheet according to this embodiment.

As can be seen, according to the above embodiment, the glass or glass sheet comprises Na₂O as a necessary component. As an alkali oxide, Na₂O is a network modifier, and, as a component of a chemically prestressable glass, enables an ion exchange of sodium ions for potassium ions. This is advantageous, as in this case, a well-known, well-mastered process may be used for chemical toughening, using an exchange bath based on potassium salt or salts, that is, well available materials at low price.

Too much Na₂O is unfavorable, however. In particular, the content of Na₂O reduces the chemical stability of the glass, particularly also the acid resistance. Therefore, according to embodiments of the glass and/or the glass article, the content of Na₂O is preferably limited.

It is known, in principal, that a certain amount of Li₂O in a glass or glass article, such as a glass sheet, to be prestressed may positively influences the formation of an optimally prestressable glass or glass article. However, as Li₂O requires rather expensive raw materials, the Li₂O content in a glass should as low as possible. It is therefore particularly advantageous that according to the present disclosure, it is possible to obtain optimized glass sheets without the need to incorporate Li₂O into the glass composition.

Therefore, according to an embodiment, the glass sheet comprises Li₂O only in an unavoidable trace amount of not more than 500 ppm per weight, in particular for embodiments of the glass sheet comprising a high amount of SiO₂ ranging from at least 79 to 85 mol%, preferably 80 to 85 mol%, a comparatively low content in Al₂O₃ ranging from at least 0.5 to 4 mol% and a B₂O₃-content ranging from 8 to 12 mol%.

In the scope of the disclosure, a glass containing Li₂O by not more than 500 ppm by weight may also be called an essentially Li₂O-free glass. Further, in the scope of the present disclosure, a glass as described above having a SiO₂ content ranging between at least 79 to 85 mol%, preferably 80 to 85 mol%, may also be called a “high SiO₂ glass” (or glass article or glass sheet, respectively).

According to an embodiment of such a chemically strengthened glass sheet, a DoL between 8.5 µm and 13.5 µm and a compressive stress of 400 MPa or less, preferably 250 MPa or less, particularly preferably 170 MPa or less, more particularly preferably 160 MPa or less, and preferably of at least 140 MPa, in particular between 140 MPa and 170 MPa, particularly preferably between 140 MPa and 160 MPa, preferably for glass sheet thicknesses between at least 3.3 mm, preferably at least 3.5 mm, more preferably at least 3.8 mm, and at most 6 mm, preferably at most 5 mm, more preferably at most 4.5 mm, is obtained. Quite surprisingly, even for such rather low stress levels of at most 400 MPa, a particular advantageous chemically strengthened glass sheet may be obtained, that is, a glass sheet combining a sufficient resistance against mechanical breakage - characterized by a high drop height in a ball drop test - combined with a superior surface resistance such as demonstrated in a gravel test according to VW80000 M-02 (ISO 20567-1), preferably for a glass sheet size of 136 by 63 mm², and the glass sheet had no break after two cycles of the gravel test.

However, according to an alternative embodiment, the chemically strengthened glass sheet comprises the following components, in mol% on an oxide basis:
SiO₂ 67 to 71, preferably 69 to 71
Al₂O₃ 10 to 12
B₂O₃ 3 to 5
Li₂O7.5 to 9
Na₂O1.0 to 2.4, preferably 2.0 to 2.4
K₂O0.1 to 0.3
MgO 0 to 1.2, preferably 1.0 to 1.2
CaO2.5 to 5, preferably 2.5 to 3.5.
SrO 0 to 0.4, preferably 0.1 to 0.4, more preferably 0.1 to 0.3

In this above embodiment of the chemically strengthened glass sheet, a comparatively low SiO₂ content varying between at least 67 and at most 71 mol% on an oxide basis, preferably between 69 to 71 mol%, is combined with a comparatively high content in Al₂O₃ of at least 10 mol% and at most 12 mol% on an oxide basis and a rather low content in B₂O₃ between at least 3 and at most 5 mol%. Such as glass (or, glass article or glass sheet, respectively) may also be called a “low SiO₂ glass” in the scope of the present disclosure.

As has already been pointed out above, glass components may interact with each other, resulting in the formation of a glass network. For the glasses of the present disclosure, as stated above, inventors found that, surprisingly, glass component contents may be varied in a rather wide range, as long as a glass structure results that may store induced stresses (and, thus, be strengthened, for example by ion exchange) while at the same time providing a good resistance of the resulting glass article or glass sheet surface against mechanical wear, such as scratching and/or abrasion.

Therefore, the advantageous mechanical properties of the glass sheet of the disclosure may also be obtained for glasses with a rather low SiO₂ and B₂O₃ and a comparatively high Al₂O₃ content as indicated by the above ranges. As inventors assume that formation of a particularly dense glass structure may also be promoted by the incorporation of lithium ions in the glass network, however, in the case of glass and glass articles, such as glass sheet with low SiO₂ and B₂O₃ and a comparatively high Al₂O₃ content, these glasses and glass articles preferably comprise Li₂O. Upon incorporation of Li₂O, a dense structure may result without the need of a high SiO₂ content. This is due to lithium ions being small ions with greater field strength. In the scope of the present disclosure, the term “field strength of an ion” is used according to Dietzel. In particular, this term is used referred to an oxidic glass matrix, wherein it is understood that this value may change, each time depending on the coordination number of the ion in question. The higher field strength of the lithium ion, compared to other alkali ions such as sodium ions, may be advantageous, since a particularly dense glass network should provide a smaller volume for deformation in the case of mechanical action, such as, for example, with the exchange of smaller ions for larger ones, as this is the case in ion exchange, and thus should oppose a mechanical deformation. This is believed to result, however, in an improvement in the prestressability, since an introduced stress would be better stored in the glass network. Therefore, according to the “low SiO₂ glasses” with only 67 to71 mol% of SiO₂, the rigidity of the glass is provided by a combination of network formers and intermediate oxides combined with network former Li₂O that is, for these “low SiO₂ glasses”, a mandatory component present in amounts from at least 7.5 to at most 9 mol% on an oxide basis (in comparison to preferably essentially Li₂O-free “high SiO₂-glasses containing SiO₂ in a range from 79 to 85 mol%).

According to one embodiment of the glass and/or of the glass article, the glass and/or the glass article therefore comprise(s) at least 7.5 mol% Li₂O.

The percentage of Li₂O should not be too high, however, and is preferably limited. As is known, when Li₂O is a component in glasses, it leads also to demixing and/or crystallization of the glass. According to embodiments of the glass and/or of the glass article, the glass and/or the glass article therefore comprise(s) at most 9 mol% Li₂O.

Further, with these “low SiO₂ glasses”, preferably glass sheets characterized by a DoCL between 250 µm and 450 µm and a compressive stress (CS(30)) of at least 250 MPa may be obtained. Even though these parameters characterizing the prestress level of a glass sheet vary from those in “high SiO₂ glasses” glass sheets, inventors found that still the advantageous mechanical properties observed in ball drop tests result. Inventors believe this to be due to the overall, holistic approach of glass composition, regarding components by the function in the glass structure, such that Li₂O, a known network modifier, may still compensate for a low SiO₂ content at least partially, if combined with tailored amounts of intermediate oxide Al₂O₃ and network former oxide B₂O₃, for example.

A further aspect of the present disclosure is directed towards a method for producing a chemically strengthened glass sheet, preferably a chemically strengthened glass sheet according to any embodiment of the present disclosure. The method comprises the followings steps:
providing a glass sheet,
providing a bath comprising a molten alkali salt or a mixture of molten alkali salts,
immersing the glass sheet in the bath, so that an ion exchange takes place,

wherein ion exchange is effected for a duration of at least 2 hours to at most 12 hours and at a temperature between at least 390° C. and at most 490° C.

According to an embodiment, the temperature is between at least 420° C. and at most 460° C., preferably at most 440° C., wherein most preferably the temperature is 420° C.

According to an embodiment, the duration is between at least 2 hours and at most 12 hours, preferably between at least 4 hours and at most 10 hours, more preferably between at least 4 hours and at most 6 hours, and most preferably the duration is 4 hours.

According to a further embodiment, the alkali salt comprises a nitrate or is a nitrate. Nitrates are preferred as these salts melt at low temperature in comparison to other alkali salts such as, for example, chlorides. Further, anion NO₃^{—} is a volatile ion that may also decompose at higher temperatures, in comparison to halide ions such as Cl^{—}. Therefore, nitrates are preferred alkali salts used in embodiments of the method of the disclosure.

According to a preferred embodiment, the method comprises only a single immersion step. That is, further ion exchange steps, as known for example for so-called LAS-glasses and glass articles that may be prestressed to very high compressive stresses such as 600 MPa or even more, are not necessary. The method proposed according to a preferred embodiment therefore is a cost-efficient method.

According to an embodiment, the glass sheet composition corresponds to a “high SiO₂ glass” glass composition and the alkali salt comprises a potassium salt, preferably KNO₃. Particularly preferably, the glass sheet comprises, in this case, Li₂O only in an unavoidable trace amount of not more than 500 ppm by weight.

A particularly suited glass composition of a “high SiO₂ glass” may be, for example, given in mol% on an oxide basis:
SiO₂ 79 to 85, preferably 80 to 85
Al₂O₃0.5 to 4
B₂O₃ 8 to 12
Na₂O2.5 to 5.2
K₂O0.3 to 1.8
MgO 0 to 3
CaO1.3 to 2.9.

However, most important, as pointed out above, is the content of oxides SiO₂, Al₂O₃ and B₂O₃, as has already explained in detail. Therefore, in general, without being restricted to the compositional ranges indicated above, a suitable “high SiO₂ glass composition” within the scope of the disclosure may be regarded as glass composition with SiO₂ ranging from 79 to 85 mol%, preferably 80 to 85 mol%, Al₂O₃ ranging from 0.5 to 4 mol% and B₂O₃ ranging from 8 to 12 mol%, with network modifiers in varying proportions filling up to 100 mol%, and wherein preferably network modifier Li₂O is only present in an unavoidable trance amount of not more than 500 ppm by weight.

Such as glass composition is preferably well adapted to an ion exchange method comprising a potassium salt, such as KNO₃.

In such a process, a “high SiO₂ glass” glass article may be obtained that is characterized by a DoL between 8.5 and 13.5 µm and a compressive stress of 400 MPa or less, preferably 250 or less, particularly preferably 170 MPa or less, more particularly preferably 160 MPa or less, and preferably of at least 140 MPa, in particular between 140 MPa and 170 MPa, preferably between 140 MPa and 160 MPa, preferably for glass sheet thicknesses between at least 3.3 mm, preferably at least 3.5 mm, more preferably at least 3.8 mm, and at most 6 mm, preferably at most 5 mm, more preferably at most 4.5 mm.

According to a further embodiment, the glass sheet composition corresponds to a “low SiO₂ glass” composition, and the alkali salt comprises a sodium salt, preferably NaNO₃.

A glass composition particularly well suited for an ion exchange based on a sodium salt, such as NaNO₃, may, for example, be given by the following ranges of components, given in mol% on an oxide basis:
SiO₂ 67 to 71, preferably 69 to 71
Al₂O₃ 10 to 12
B₂O₃ 3 to 5
Li₂O7.5 to 9
Na₂O1.0 to 2.4, preferably 2.0 to 2.4
K₂O0.1 to 0.3.
MgO 0 to 1.2, preferably 1.0 to 1.2
CaO2.5 to 5, preferably 2.5 to 3.5.
SrO 0 to 0.4, preferably 0.1 to 0.4, more preferably 0.1 to 0.3

However, generally, without being restricted to the compositional ranges indicated above, in general a glass composition suited for a method according to embodiments with a SiO₂ content ranging from 67 to 71 mol% on an oxide basis, a Al₂O₃ content ranging from 10 to 12 mol% on an oxide basis and a B₂O₃ content ranging from 3 to 5 % mol% on an oxide basis and further comprising Li₂O, in particular in a range ranging from at least 7.5 and at most 9 mol% on an oxide basis, is regarded as “low SiO₂ glass” composition and may be prestressed by an ion exchange according to embodiments of the disclosure, in particular based on a sodium salt, such as NaNO₃.

Preferably, for such “low SiO₂ glasses”, the corresponding glass sheet is characterized by a DoCL between 8.5 and 13.5 µm and a compressive stress (CS30) of 700 MPa or less, and preferably of at least 250 MPa, in particular between 260 and 450 MPa, preferably for glass sheet thicknesses between at least 3.3 mm, preferably at least 3.5 mm, more preferably at least 3.8 mm, and at most 6 mm, preferably at most 5 mm, more preferably at most 4.5 mm.

A yet further aspect of the present disclosure is directed towards the use of the chemically strengthened glass sheet according to embodiments and/or produced in a method according to embodiments as a cover glass for a protective housing for an optical sensor, in particular a LiDAR sensor.

Further, the present application relates to a glass sheet produced in a method according to embodiments of the disclosure.

### EXAMPLES

The following table comprises some examples of glass compositions according to different embodiments of the present disclosure. In the table, all components are given in mol%. Data were obtained by analysis of melted glass bodies and samples, so that composition may add up to more than 100 mol% or to less than 100 mol% due to analytical errors.

| Example no. | unit | 1 | 2 | 3 | 4 | 5 | 6 | 7 |
|---|---|---|---|---|---|---|---|---|
| Composition | | | | | | | | |
| SiO₂ | | 83.3 | 81.6 | 80 | 67.3 | 69.7 | 68.9 | 69.5 |
| B₂O₃ | | 11.3 | 8.9 | 8.7 | 8.2 | 3.6 | 3.4 | 3.5 |
| Al₂O₃ | | 1.5 | 2.6 | 1.5 | 6.5 | 11.1 | 11.0 | 11.3 |
| Li₂O | | | | | | 7.9 | 8.7 | 8.2 |
| Na₂O | | 3.5 | 5 | 2.8 | 5.1 | 2.2 | 1.1 | 1.6 |
| K₂O | | 0.4 | 0.4 | 1.6 | 0.5 | 0.2 | 0.2 | 0.2 |
| MgO | | | | 2.8 | 7.1 | 1.1 | | |
| CaO | | | 1.4 | 2.7 | 3.4 | 2.9 | 4.6 | 4.2 |
| SrO | | | | | 2.0 | 0.2 | 0.4 | 0.3 |
| BaO | | | | | | | | |
| ZnO | | | | | | 0.12 | 0.4 | 0.12 |
| TiO₂ | | | | | | 0.01 | | |
| ZrO₂ | | | | | | 0.1 | 0.4 | 0.42 |
| P₂O₅ | | | | | | 0.27 | 0.6 | 0.32 |
| SnO₂ | | | | | | 0.1 | 0.2 | 0.05 |
| NaCl | | 0.1 | 0.23 | | 0.27 | 0.25 | | |
| NaF | | | | | | | | |
| SO₃ | | | | | | 0 | | |
| Sb₂O₃ / As₂O₃ | | | | | | | | |
| CeO₂ | | | | | | 0.15 | 0.18 | 0.28 |
| Fe₂O₃ | | | | | | 0.00 | | |
| Nd₂O₃ | | | | | | | | |
| Hydrolyt. Resis. H | class | HGB 1 | HGB 1 | HGB1 | | HGB1 | | |
| Hydrolyt. Resis. H | äqu. Na₂O [µg/g] | 8 | | 27 | | 32 | | |
| Acid resis. S | class | S1 | S1 | S1 | | S2 | | |
| Acid resis. S | mg/dm² | 0.6 | | <0.3 | | 1.4 | | |
| Alkali resis. L | class | A2 | A2 | A2 | | A2 | | |
| Alkali resis. L | mg/dm² | 164 | | 116 | | 92 | | |
| Photo-elastic constant C @640 nm | nm/cm MPa | 40 | | 33.7 | | 29.8 | | |
| Field strength | | 1.50 | 1.46 | 1.43 | 1.31 | 1.31 | 1.30 | 1.30 |
| SiO₂+B₂O₃+Al₂O₃ | mol% | 96.1 | 93.1 | 90.2 | 82 | 84.4 | 83.3 | 84.3 |
| SiO₂+B₂O₃ | mol% | 94.6 | 90.5 | 88.7 | 75.5 | 73.3 | 72.5 | 73.2 |
| R₂O + RO | mol% | 3.9 | 6.8 | 9.9 | 18.1 | 14.3 | 15.1 | 14.5 |

Chemical resistance (hydrolytic resistance H, acid resistance A, basic resistance L) was determined according to the following standards: Hydrolytic resistance of a glass is determined and a hydrolytic class is specified according to the regulations of ISO 719 and DIN 12111, respectively. Depending on the quantity of extracted glass constituents, correspondingly tested glasses are classified into classes. Class 1 indicates the class in which only a small amount of material was extracted, and the class number increases with increasing leaching of the glass by hydrolytic attack. Acid resistance and the acid class of a glass are determined according to the regulations of DIN 12116. Here, again, classification into a class is made according to the amount of extracted glass constituents, and the best class is again Class 1. Alkali resistance and the alkali class of a glass are determined according to the regulations of ISO 695 and DIN 52322, respectively. Again, the best class, i.e. the one with the highest alkali resistance, is Class 1.

Gravel test according to VW80000 M-02 (ISO 20567-1) was performed with 500 g of the gravel medium. Test pressure was set to 2 bar. The gravel medium used as chilled iron grit as per DIN EN ISO 11124-2 with a grain size ranging from 4 mm to 5 mm. The device under test, that is, the glass sheet, was set at an angle of 54° to the blasting direction of the gravel material. The test equipment used was a multiple stone-impact device as per DIN EN ISO 20567-1.

Ball drop testing was performed with a steel ball of 500 g and a diameter of 50 mm. The sample to be tested was placed on a sample holder that is shown schematically and not drawn to scale in FIG. 1.

The following table shows examples of glass sheets according to embodiments of the disclosure as well as comparative examples. The material refers to the compositions given in the table further above. Thickness is indicated, as well as the toughening protocol, if the sample in question were toughened. “CV” refers to “characteristic values” after multiple stone-impact testing according to DIN EN ISO 20567-1. Comp. refers to a glass sheet comprising a soda-lime glass.

“Breakage” here refers to breakage occurring after two test cycles of gravel test according to VW80000 M-02 (ISO 20567-1, preferably for a glass sheet size of 136 by 63 mm². If no breakage occurs, the test is passed.

| Material | Thickness | Toughening protocol | CS | DoL | CS (30) | DoCL | Balldrop | CV | Breakage |
|---|---|---|---|---|---|---|---|---|---|
| | | | MPa | µm | MPa | µm | | | |
| No. 3 | 4 mm | | | | | | pass 350 mm | 2.0-2.5 | |
| No. 3 | 4 mm | 420° C. / 4 h KNO₃ | 153 | 9.51 | | | pass 350 mm | 1.5 | No |
| No. 3 | 4 mm | | | | | | 400 | 1.0 | No |
| No. 3^{#} | 4 mm | | | | | | 450 | 1.5 | No |
| No. 3^{#} | 4 mm | 380° C. / 4 h KNO₃ | | | | | 735 | 1.5 | No |
| No. 3^{#} | 4 mm | 380° C. / 8 h KNO₃ | | | | | 655 | 1.5 | No |
| No. 3^{#} | 4 mm | 460° C. / 4 h KNO₃ | 160 | 15.14 | | | 605 | 1.0 | No |
| No. 3^{#} | 4 mm | 460° C. / 8 h KNO₃ | 162 | 22.03 | | | 760 | 1.0 | No |
| No. 1 | 3.8 mm | | | | | | fail 288 mm | 2.0-2.5 | Yes |
| No. 1 | 3.8 mm | 430° C. / 8 h KNO₃ | 161 | 9.61 | | | pass 560 mm | | No |
| No. 1 | 3.8 mm | 460° C. / 5 h KNO₃ | 153 | 9.3 | | | pass 450 mm | | No |
| No. 1 | 3.8 mm | 420° C. / 10 h KNO₃ | 163 | 9.4 | | | pass 705 mm | 1.0-1.5 | No |
| No. 1 | 3.8 mm | 420° C. / 10 h KNO₃ | | | | | | | No |
| No. 1 | 3.8 mm | 440° C. / 7 h KNO₃ | 159 | 9.49 | | | pass 460 mm | | No |
| No. 1 | 3.3 mm | 420° C. / 10 h KNO₃ | | | | | pass 392 mm | | No |
| No. 5 | 1.8 mm | | | | | | failed 283 mm | | |
| No. 5 | 1.8 mm | 440° C. / 12 h NaNO₃ | | | 261 | 297 | failed 262 mm | | |
| No. 5 | 1.8 mm | 420° C. / 12 h 50% KNO₃ + 50% NaNO₃ | | | 265 | 259 | failed 268 mm | | |
| No. 5^{#} | 4.0 mm | 440° C. / 12 h NaNO₃ (1) | | | 277 | 364 | pass 750 mm | | |
| No. 5^{#} | 4.0 mm | 420° C. / 12 h 50% KNO₃ + 50% NaNO₃ | | | 259 | 334 | pass 612 mm | | |
| No. 5^{#} | 4.0 mm | | | | | | 455 | 1.5 | No |
| No. 5^{#} | 4.0 mm | 410° C.12 h NaNO₃ + 3 h KNO₃390° C. | 991 | 4.1 | 278 | 391 | 1230 | | Yes |
| No. 5^{#} | 4.0 mm | 3 h % KNO₃ 390° C. | 952 | 3.9 | | | 1235 | 1.0 | No |
| No. 5^{#} | 4.0 mm | 410° C.12 h NaNO₃ | | | 314 | 338 | 925 | | Yes |
| Comp. | 4.0 mm | 420° C. / 4 h KNO₃ | 640 | 9.6 | | | pass 767 mm | 2.5-3.0 | Yes |

^{#} samples polished prior to toughening and/or testing

According to DIN EN ISO 20567-1:2017-07, the characteristic values correspond to the following maximum damaged surface areas:
a) Characteristic value 0.5 damaged area 0.2%
b) Characteristic value 1.0 damaged area 1.0%
c) Characteristic value 1.5 damaged area 2.5%
d) Characteristic value 2.0 damaged area 5.5%
e) Characteristic value 2.5 damaged area 10.7%
f) Characteristic value 3.0 damaged area 19.2%
g) Characteristic value 3.5 damaged area 29.0%
h) Characteristic value 4.0 damaged area 43.8%
i) Characteristic value 4.5 damaged area 58.3%
j) Characteristic value 5.0 damaged area 81.3%

Therefore, in general, without being limited to any particular embodiment, the present disclosure is also directed towards a chemically strengthened glass sheet having a thickness of at least 3.3 mm, preferably at least 3.5 mm, more preferably at least 3.8 mm and at most 6 mm, preferably at most 5 mm, more preferably at most 4.5 mm, comprising, in mol% on an oxide basis, the following components:
SiO₂ 65 to 85
B₂O₃ 3 to 13

$$\sum \left({\text{R}}_{2} \text{O} + \text{RO}\right)$$
3 to 19

wherein R₂O represents any of Li₂O, Na₂O, and K₂O, and any combination thereof, and wherein RO represents any of MgO, CaO, and BaO, and any combination thereof,

and wherein a characteristic value, CV, after multiple stone-impact testing according to DIN EN ISO 20567-1, preferably for a glass sheet size of 136 by 63 mm², is at most 1.5, preferably between 1.0 to 1.5.

In general, gravel testing may be performed for one sample. However, in order to provide for statistic effects, a multitude of test samples may be used, for example about 10 samples.

As can be seen from the above data, a soda-lime glass sheet may be toughened and may also pass the ball drop test; however, the glass sheet will break during gravel test. With respect to composition no. 5, the influence of glass sheet thickness may be illustrated. Low glass thickness lead to failure in ball drop testing, whereas higher glass sheet thicknesses of at least 3.3 mm, preferably at least 3.5 mm, more preferably at least 3.8 mm, or even 4 mm, significantly improve test results in ball drop testing.

Further, test results show that high SiO₂-glass sheets, such as borosilicate glass sheets, that were ion-exchanged showed no breakage after two test cycles of gravel test.

Inventors further found that polishing of the glass sheets prior to testing and/or prior to toughening may result in improved test results and, thus, improved product quality. For example, for glass sheets comprising glasses with a “high SiO₂-content”, such as for glass composition no.3, polishing of glass sheets results in improved results in ball drop testing. However, for these high SiO₂-glasses, polishing also leads to an increase in surface damage during gravel testing.

The higher the temperature during toughening, especially for high SiO₂-glasses, the lower the amount of surface damage during gravel testing, as can be seen for the increase of toughening temperature from 380° C. to 460° C.

All glasses show an increase in ball drop heights through chemical toughening, an effect that is most pronounced in glasses with low SiO₂-contents, such as glass no. 5

Generally speaking, chemical toughening leads to an increase in surface resistance during gravel testing.

Therefore, according to an embodiment, and without being restricted to any of the specific embodiments of the disclosure, glass sheets may also be polished.

The present disclosure therefore also relates to a process for producing a glass sheet, especially a glass sheet according to any of the embodiments of the disclosure, comprising a surface polishing step. Generally, both sides of a glass sheet of the disclosure may be polished, but it may also be contemplated to polish only one side of a glass sheet. Polishing may take place during manufacture prior to toughening.

### DESCRIPTION OF FIGURES

The present invention will now be further explained with reference to the following figures. In the figures, like reference numerals refer to the same or corresponding elements.

FIG. 1 schematically and not drawn to scale a test set up of a ball drop test,

FIG. 2 schematically and not drawn to scale a glass sheet according to embodiments of the disclosure, and

FIGS. 3 to 5 show photographs of samples according to the disclosure as well as of a comparative example after gravel testing.

### DETAILED DESCRIPTION

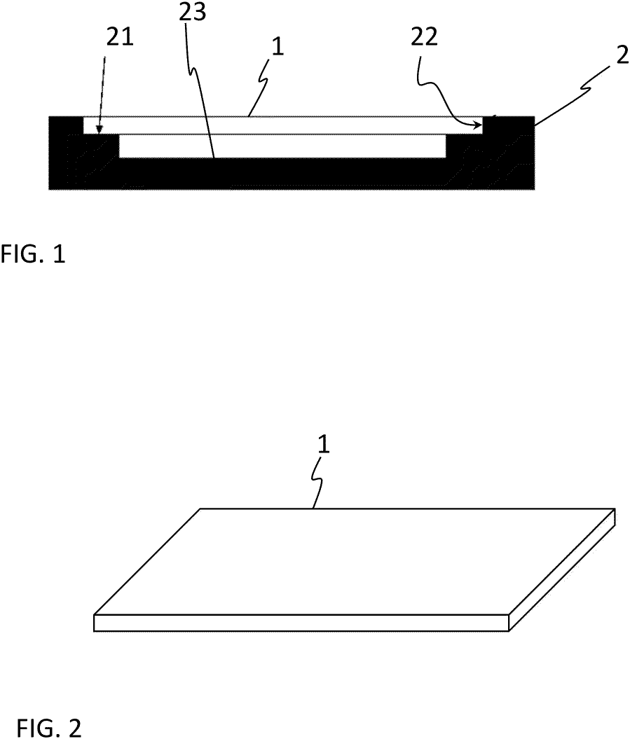

FIG. 1 shows schematically and not drawn to scale glass sheet 1 according to an embodiment in a sectional view, placed onto sample holder 2 for the so-called ball drop test.

Sample holder 2 has an overall thickness of 10 mm of a phenolic resin. Further, in order to accurately position glass sheet 1 sample holder 2 comprises a step, characterized by a tread 21 with a width of about 10 mm and riser 22 of 3.4 mm.

Further, sample holder 2 comprises a middle portion step 23 (or depression 23) arranged under a central portion of glass sheet 1. Glass sheet 1 has, in the example depicted in FIG. 1, as size of about 136 by 63 mm².

FIG. 2 shows a perspective view of a schematic and not drawn to scale glass sheet according to embodiments of the disclosure.

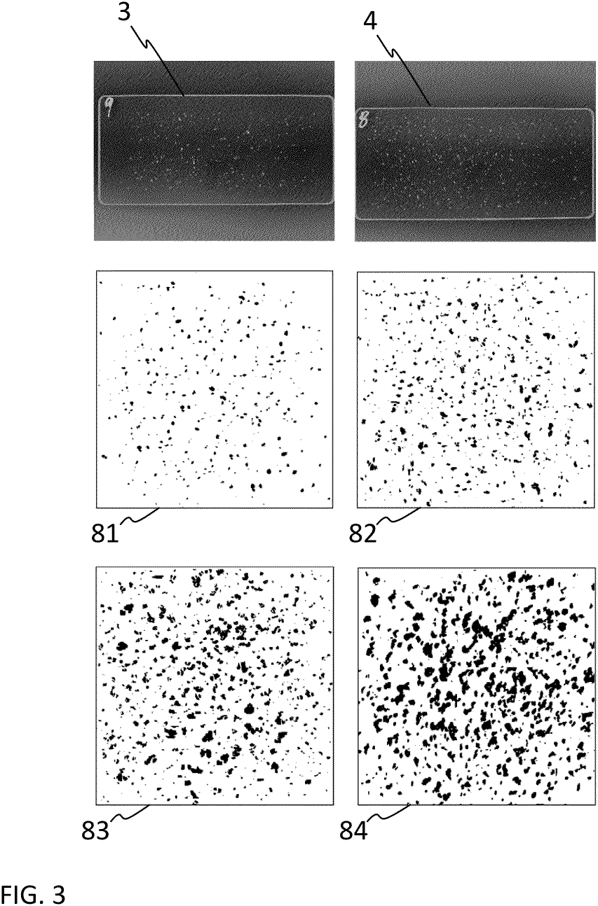

FIG. 3 shows in the upper part to photographs of samples 3 and 4, corresponding to samples of material no. 3. Here, sample 3 is a chemically strengthened sample after gravel testing, whereas sample 4 is a non-strengthened sample. Further, FIG. 3 shows reference surface according to DIN EN ISO 20567-1 for characteristic values of 1.0 (reference numeral 81), of 2.0 (reference numeral 82), of 2.5 (reference numeral 83), and of 3.0 (reference numeral 84), respectively. As can be seen upon comparison with these reference surface 81 to 84, sample 3 has lesser surface damage, resulting in a CV of 1.5, whereas the higher surface damage visible in non-strengthened sample 4 results in CV 2.0 to 2.5.

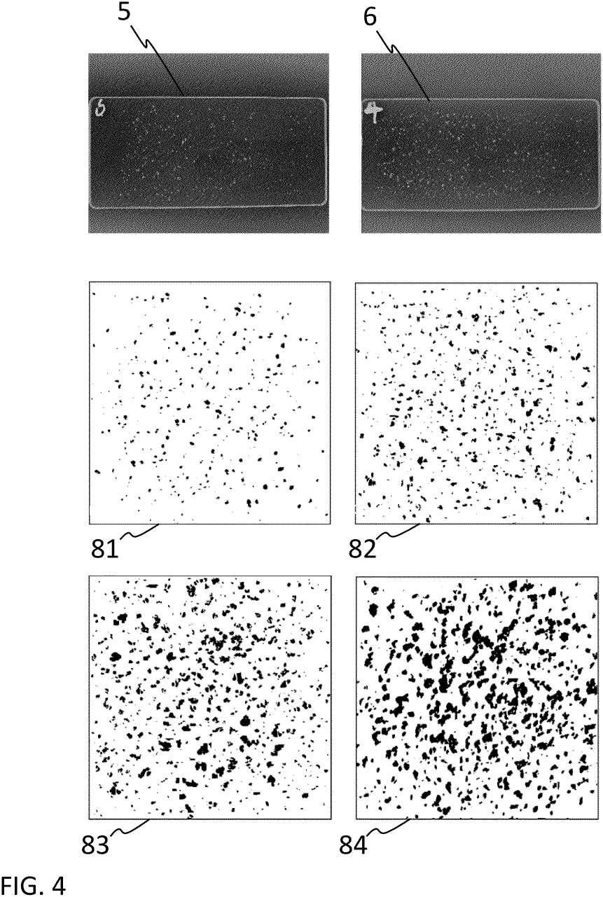

FIG. 4 shows in the upper part to photographs of samples 5 and 6, corresponding to samples of material no. 1. Here, sample 5 is again a chemically strengthened sample after gravel testing, whereas sample 6 is a non-strengthened sample. Further, FIG. 4 shows reference surface according to DIN EN ISO 20567-1 for characteristic values of 1.0 (reference numeral 81), of 2.0 (reference numeral 82), of 2.5 (reference numeral 83), and of 3.0 (reference numeral 84), respectively. As can be seen upon comparison with these reference surface 81 to 84, sample 5 has lesser surface damage, resulting in a CV of 1.5, whereas the higher surface damage visible in non-strengthened sample 6 results in CV 2.0 to 2.5.

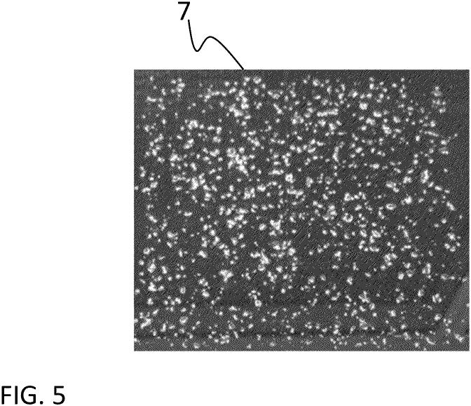

Further, FIG. 5 shows a photograph of sample 7 corresponding to the comparative example after gravel testing. This gravel testing results in a higher amount of deteriorated surface area that in samples 3 and 5 according to the disclosure. The corresponding CV is. 3.0.

Whereas even samples that have not been chemically strengthened (see samples 4 and 6 in FIGS. 3 and 4, respectively) show a lesser degree of surface defects in comparison sample 7, this already good performance can be optimized by strengthening, as can be seen for samples 3 and 5, as explained above.

### LIST OF REFERENCE NUMERALS

1 Glass sheet
2 sample holder
21 step tread 21
22 riser 22
23 middle portion, depression of sample holder
3 sample for material no. 3, chemically strengthened
4 sample for material no. 3, not strengthened
5 sample for material no. 1, not strengthened
6 sample for material no. 1, chemically strengthened
7 comparative example, chemically strengthened
81 CV example according to DIN EN ISO 20567-1, CV 1.5
82 CV example according to DIN EN ISO 20567-1, CV 2.0
83 CV example according to DIN EN ISO 20567-1, CV 2.5
84 CV example according to DIN EN ISO 20567-1, CV 3.0

What is claimed is:

1. A chemically strengthened glass sheet, comprising:
a thickness of at least 3.3 mm and at most 6.0 mm; and
a composition, in mol% on an oxide basis, comprising the following components:
SiO₂ 65 to 85
B₂O₃ 3 to 13
∑ (R₂O + RO) 3 to 19
wherein R₂O represents any of Li₂O, Na₂O, and K₂O, and any combination thereof, and
wherein RO represents any of MgO, CaO, SrO and BaO, and any combination thereof.

2. The chemically strengthened glass sheet of claim 1, wherein the glass sheet shows no breakage after two cycles of gravel test according to VW80000 M-02 (ISO 20567-1.

3. The chemically strengthened glass sheet of claim 2, wherein the glass sheet has a size of 136 by 63 mm².

4. The chemically strengthened glass sheet of claim 1, wherein the glass sheet has for a size of 136 by 63 mm² and passes a ball drop test according to PV 3905 with a drop height of at least 30 cm using a 500 g steel ball with a diameter of 50 mm.

5. The chemically strengthened glass sheet of claim 1, wherein the thickness is at least 3.8 mm and at most 4.5 mm.

6. The chemically strengthened glass sheet of claim 1, further comprising:
a sum of components SiO₂, B₂O₃, and Al₂O₃ that is at least 80 and at most 98; and
an oxide content of a network modifier, given in mol% on an oxide basis, of at least 3 and at most 19,
wherein the network modifier is selected from a group consisting of Li₂O, Na₂O, K₂O, MgO, CaO, SrO, BaO, and any combination thereof.

7. The chemically strengthened glass sheet of claim 6, wherein the sum of components SiO₂, B₂O₃, and Al₂O₃ is at least 90 and at most 91 and/or wherein the oxide content of the network modifier is at most 11.

8. The chemically strengthened glass sheet of claim 1, further comprising a sum of SiO₂ and B₂O₃ that is between at least 72 and at most 95.

9. The chemically strengthened glass sheet of claim 1, wherein the composition comprises, in mol% on an oxide basis:
SiO₂ 79 to 85
Al₂O₃0.5 to 4
B₂O₃ 8 to 12
Na₂O2.5 to 5.2
K₂O0.3 to 1.8
MgO 0 to 3
CaO 1.3 to 2.9.

10. The chemically strengthened glass sheet of claim 1, wherein the composition comprises Li₂O in an amount of not more than 500 ppm per weight.

11. The chemically strengthened glass sheet of claim 1, further comprising:
a DoL between 8.5 and 13.5 µm; and
a compressive stress of 400 MPa or less and at least 140 MPa.

12. The chemically strengthened glass sheet of claim 1, wherein the composition comprises, in mol% on an oxide basis:
SiO₂ 67 to 71
Al₂O₃ 10 to 12
B₂O₃ 3 to 5
Li₂O7.5 to 9
Na₂O41.0 to 2.4
K₂O0.1 to 0.3
MgO 0 to 1.2
CaO2.5 to 5
SrO 0 to 0.4.

13. The chemically strengthened glass sheet of claim 1, further comprising:
a DoCL between 8.5 and 13.5 µm; and
a compressive stress (CS30) of not more than 700 MPa and at least 250 MPa.

14. A method for producing a chemically strengthened glass sheet, comprising:
providing a glass sheet;
providing a bath comprising a molten alkali salt or a mixture of molten alkali salts; and
immersing the glass sheet in the bath for a duration of at least 2 hours to at most 12 hours and at a temperature between at least 400° C. and at most 480° C. so that an ion exchange takes place.

15. The method of claim 14, wherein the temperature is between at least 420° C. and at most 460° C.

16. The method of claim 14, wherein the temperature is 420° C.

17. The method of claim 14, wherein the duration is between at least 2 hours and at most 8 hours.

18. The method of claim 14, wherein the duration is 4 hours.

19. The method of claim 14, wherein the molten alkali salt or the mixture of molten alkali salts comprises a nitrate or is a nitrate.

20. The method of claim 14, wherein the step of immersing consists of a single immersion.
